(19) United States
(12) Patent Application Publication
(10) Pub. No.: US 2016/0140355 A1
(43) Pub. Date: May 19, 2016

(54) USER TRUST SCORES BASED ON REGISTRATION FEATURES

(71) Applicant: salesforce.com, inc., San Francisco, CA (US)

(72) Inventors: Arun Jagota, Sunnyvale, CA (US); Gregory Haardt, San Carlos, CA (US); Govardana Sachithanandam Ramachandran, San Jose, CA (US); Stanislav Georgiev, Sunnyvale, CA (US); Matthew Fuchs Fuchs, Los Gatos, CA (US)

(21) Appl. No.: 14/548,027

(22) Filed: Nov. 19, 2014

(51) Int. Cl. G06F 21/62; G06F 21/50

(52) U.S. Cl. CPC G06F 21/6218; G06F 21/50; G06F 2221/031

(57) ABSTRACT

User trust scores based on registration features is described. A system identifies registration features associated with a user registered to interact with a database. The system calculates a registration trust score for the user based on a comparison of multiple registration features associated with the user to corresponding registration features associated with previous users who are restricted from interacting with the database and/or corresponding registration features associated with previous users who are enabled to interact with the database. The system restricts the user from interacting with the database if the registration trust score is above a registration threshold.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Some database users provide many record updates, such as adding and updating business contact records. A database system may not be able to differentiate between the new users who register to provide updates and/or purchase business contact records and those new users who register to maliciously provide fraudulent updates. A database system may not be able to identify those new users who are fraudulent users until after these users have already provided a significant number of fraudulent updates to the database.

### BRIEF SUMMARY

In accordance with embodiments, there are provided systems and methods for user trust scores based on registration features. Registration features are identified which are associated with a user registered to interact with a database. A registration trust score is calculated for the user based on a comparison of multiple registration features associated with the user to corresponding registration features associated with previous users who are restricted from interacting with the database and/or corresponding registration features associated with previous users who are enabled to interact with the database. The user is restricted from interacting with the database if the registration trust score is above a registration threshold.

For example, a system identifies that a user, who just registered to interact with a database, used a first name of Mickey, a last name of Mouse, an email address of mickey.mouse@hackers.com, an Internet Protocol Address associated with a prison, and registered at 5 A.M. on a Sunday morning of a holiday weekend. The system calculates a registration trust score of 95 for the user based on comparing many of the user's registration features against many of the registration features of previous users who are locked out from accessing the database, many of whom used cartoon character names to register via hackers.com. The system restricts the user from interacting with the database because the user's registration trust score of 95 is above a registration threshold of 90.

While one or more implementations and techniques are described with reference to an embodiment in which user trust scores based on registration features is implemented in a system having an application server providing a front end for an on-demand database service capable of supporting multiple tenants, the one or more implementations and techniques are not limited to multi-tenant databases nor deployment on application servers. Embodiments may be practiced using other database architectures, i.e., ORACLE®, DB2® by IBM and the like without departing from the scope of the embodiments claimed.

Any of the above embodiments may be used alone or together with one another in any combination. The one or more implementations encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

### BRIEF DESCRIPTION OF THE DRAWINGS

In the following drawings like reference numbers are used to refer to like elements. Although the following figures depict various examples, the one or more implementations are not limited to the examples depicted in the figures.

FIG. 1 is an operational flow diagram illustrating a high level overview of a method for user trust scores based on registration features, in an embodiment;

FIG. 2 is an example table of registration features for user trust scores based on registration features, in an embodiment;

FIG. 3 illustrates a block diagram of an example of an environment wherein an on-demand database service might be used; and

FIG. 4 illustrates a block diagram of an embodiment of elements of FIG. 3 and various possible interconnections between these elements.

### DETAILED DESCRIPTION

### General Overview

Systems and methods are provided for user trust scores based on registration features. As used herein, the term multi-tenant database system refers to those systems in which various elements of hardware and software of the database system may be shared by one or more customers. For example, a given application server may simultaneously process requests for a great number of customers, and a given database table may store rows for a potentially much greater number of customers. As used herein, the term query plan refers to a set of steps used to access information in a database system. Next, mechanisms and methods for user trust scores based on registration features will be described with reference to example embodiments. The following detailed description will first describe a method for user trust scores based on registration features. Next, an example table of registration features for user trust scores based on registration features is described.

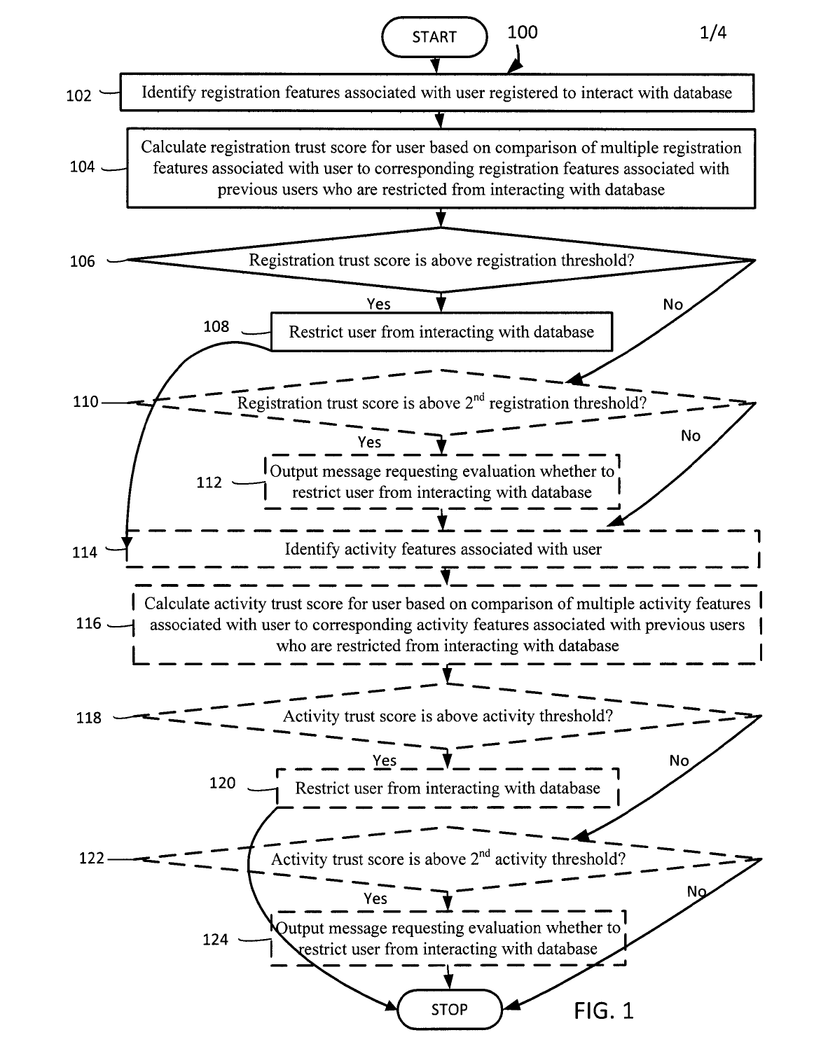

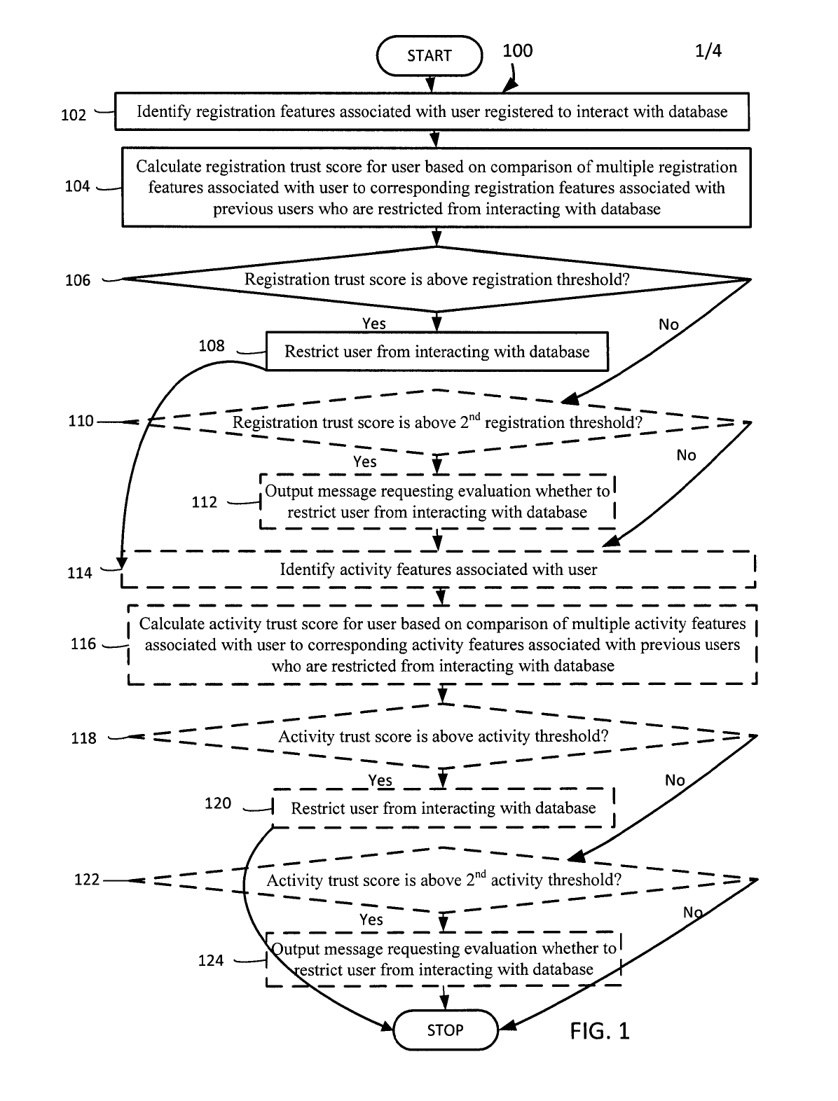

FIG. 1 is an operational flow diagram illustrating a high level overview of a method 100 for user trust scores based on registration features. As shown in FIG. 1, a database system may calculate and apply user trust scores based on registration features.

A database system identifies registration features associated with a user registered to interact with a database, block 102. For example and without limitation, this can include the database system identifying that a user, who just registered to interact with a database, used a first name of Mickey, a last name of Mouse, an email address of mickey.mouse@hackers.com, an Internet Protocol Address associated with a prison, and registered at 5 A.M. on a Sunday morning of a holiday weekend. The database system may identify as many registration features for the user as possible, because over time some registration features which were not previously associated with fraudulent users may become to be associated with fraudulent users.

Examples of registration features include the hour of day when a user registered, the day of week when a user registered, the first name used for registration, the number of words in the first name used for registration, the last name used for registration, and the number of words in the last name used for registration. More examples of registration features include the email address used for registration, the domain of the email address used for registration, the prefix of the email address used for registration, the first block of the Internet Protocol (IP) address used for registration, the second block of the IP address used for registration, the third block of the IP address used for registration, the fourth block of the IP address used for registration.

Having identified a user's registration features, the database system calculates a registration trust score for the user based on a comparison of multiple registration features associated with the user to corresponding registration features associated with previous users who are restricted from interacting with the database and/or corresponding registration features associated with previous users who are enabled to interact with the database, block 104. By way of example and without limitation, this can include the database system calculating a registration trust score of 95 for the user based on comparing many of the user's registration features against many of the registration features of previous users who are locked out from accessing the database, many of whom used cartoon character names to register via hackers.com. The database system may also calculate a registration trust score of 95 for the user based on comparing many of the user's registration features against many of the registration features of previous users who are currently enabled to access the database, few of whom used cartoon character names to register via hackers.com. The comparison is discriminative in that a user's registration features may be compared with corresponding registration features of fraudulent users as well as the registration features of good users. If a user's registration features fit the registration features of fraudulent users more than they fit the registration features of good users, then the new user is likely to be a fraudulent user.

Although this example describes individual registration features, such as users who register via the domain name “hackers.com,” the database system does not calculate a registration trust score based on any single registration feature or use any single registration feature to determine whether or not to restrict a user from interacting with the database. For example, many legitimate users may register via the domain name “hackers.com,” such that the database system would be making an incorrect decision by calculating the registration trust score based only on the domain name or determining to restrict the user from interacting with the database based only on the domain name. The database system calculates a user's registration trust score based on a combination of registration features, which when evaluated alone are insufficient to accurately predict whether a user is likely to be a fraudulent user.

Although the following simplified example describes the database system assigning a weight to registration features associated with previous users, the database system may use more advanced machine learning algorithms to leverage dependencies among registration features to yield potentially more accurate predictions. In this example, the database system may assign a weight to each of the registration features based on the corresponding registration features associated with previous users who are restricted from interacting with the database and/or the corresponding registration features associated with previous users who are currently enabled to interact with the database. The database system may train with the registration features associated with half of the previous users who are locked out from accessing the database to identify correlations between each registration feature and these fraudulent users.

Next the database system may assign weights based on the correlations, such as assigning a weight to certain cartoon character names that is 2.5 times the weight of the weight assigned to certain domain names. Then the database system may calculate registration trust scores for the registration features associated with the remaining half of the previous users who are locked out from accessing the database to verify that the weights are assigned correctly, and may adjust the assigned weights as needed.

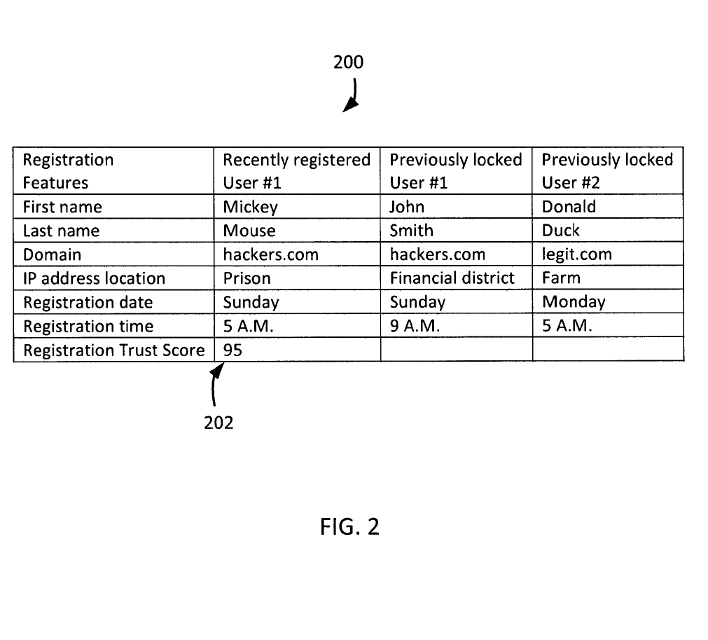

An example table of registration features for user trust scores based on registration features is depicted in FIG. 2 and described below in the description of FIG. 2. The database system may conserve system resources by calculating a registration trust score only for newly registered users who actually interact with the database, instead of attempting to calculate registration trust scores for all recently registered users, many of whom may wait a considerable amount of time before attempting to interact with the database.

Having calculated the user's registration trust score, the database system determines whether the registration trust score is above a registration threshold, block 106. In embodiments, this can include the database system comparing the user's registration trust score of 95 to a registration threshold of 90. If the database system determines that the registration trust score is above the registration threshold, the method 100 continues to block 108. If the database system determines that the registration trust score is not above the registration threshold, the method 100 proceeds to block 110.

The following example describes how database system may calculate the registration threshold based on a desired precision and recall. In the data set (ru, c, t), u denotes a user, ru denotes the user's vector of registration features, c denotes whether u is fraudulent (F) or not (N), and t denotes the time when the user registered. The database system may hold out some recent data, such as the most recent two months of data in terms of registration time, for setting the registration threshold, and train the classifier on the rest of the data.

Once the model has been trained, the database system may choose the registration threshold by evaluating the trained model's accuracy on the held-out set of data. The database system may output the trained classifier's user trust score for each item in the held-out set. Examples of user trust scores may include the highest possible score of 100 for a fraudulent user and the lowest possible score of 0 for a strongly trusted user. The database system's output results in triples of the form (ru, c, su), one for each item in the held-out set of data. On this set of triples, and for any threshold tr in (0,100), the precision and recall of the F class are defined as follows. Precision(tr)=(# triples in which su>=tr and c is F) divided by (# triples in which su>=tr). Recall(tr)=(# triples in which su>=tr and c is F) divided by (# triples in which c is F). Thus, precision(tr) is the fraction of users predicted to be F that are actually F, and recall(tr) is the fraction of users that are actually F that also get predicted as F. Varying tr tends to vary the trade-off between precision(tr) and recall(tr).

The database system's administrator is interested in finding the smallest threshold that achieves a given minimum precision threshold. For example, an administrator of the database system might be willing to tolerate 90% precision of F class, which means a willingness to tolerate up to 1 of 10 predictions that are F being wrong. For this threshold, the registration threshold that the database system administrator may choose would be the smallest value of tr that achieves a precision no less than this. The reason that the database system administrator may pick the smallest value of the registration threshold is because it will have the highest recall.

If the registration trust score is above the registration threshold, the database system restricts the user from interacting with the database, block 108. For example and without limitation, this can include the database system restricting the user from interacting with the database because the user's registration trust score of 95 is above the registration threshold of 90. Then the method 100 may proceed to block 114.

If the registration trust score is not above the registration threshold, the database system may optionally determine whether the registration trust score is above an auxiliary registration threshold, block 110. By way of example and without limitation, this can include the database system comparing a user's registration trust score of 85 to an auxiliary registration threshold of 80. If the database system determines that the registration trust score is above the auxiliary registration threshold, the method 100 continues to block 112. If the database system determines that the registration trust score is not above the auxiliary registration threshold, the method 100 proceeds to block 114.

If the registration trust score is above the auxiliary registration threshold, the database system may optionally output a message requesting evaluation whether to restrict user from interacting with database, block 112. In embodiments, this can include the database system notifying system administrators that the user's registration trust score of 85 is above the auxiliary registration threshold of 80, which enables to system administrators to review the user's registration features and determine whether or not to lock out the user from accessing the database.

If the registration trust score is not above the auxiliary registration threshold, the database system may optionally identify activity features associated with the user, block 114. For example and without limitation, this can include the database system identifying that the user provided bulk updates of 1,000 contacts within the first 15 minutes of registering, and all of the 1,000 updates were for email addresses and telephone numbers for employees of a single corporation. The database system may identify as many activity features for the user as possible, because over time some activity features which were not previously associated with fraudulent users may become to be associated with fraudulent users.

Examples of activity features include the number of contacts added on the first day of registration, the number of contacts added during the first 30 days of registration, the total number of contacts added, the number of contacts updated on the first day of registration, the number of contacts updated during the first 30 days of registration, and the total number of contacts updated. More examples of activity features include the number of contacts purchased on the first day of registration, the number of contacts purchased during the first 30 days of registration, the total number of contacts purchased, and the total number of companies added. Additional examples of activity features include the total number of companies updated, the number of updates of first names, the number of updates of last names, the number of updates of titles, the number of updates of email addresses, the number of updates of phone numbers, and the number of updates of addresses. Further examples of activity features include the time to the 20^{th} contribution (add or update), the percentage of contributions that are to companies, the percentage of all updates that are major (a change of a phone number or an email address of a contact is called major, while all other updates are called minor), and the percentage of all updates that are minor. Even more examples of activity features include the percentage of all updates that are graveyards (such as flagging a contact as “not live”, which means “no longer at the company”), the percentage of all updates that change the first name, the percentage of all updates that change the last name, the percentage of all updates that change the title, the percentage of all updates that change the email address, and the number of bulk files submitted in the first week of registration.

Having identified the user's activity features, the database system may optionally calculate an activity trust score for the user based on a comparison of multiple activity features associated with the user to corresponding activity features associated with previous users who are restricted from interacting with database and/or corresponding activity features associated with previous users who are enabled to interact with the database, block 116. By way of example and without limitation, this can include the database system calculating an activity trust score of 90 for the user based on comparing many of the user's activity features against many of the activity features of previous users who are locked out from accessing the database, many of whom provided bulks updates of email addresses and phone numbers for employees of a single corporation.

The database system may also calculate an activity trust score of 90 for the user based on comparing many of the user's activity features against many of the activity features of previous users who are currently enabled to access the database, few of whom provided bulks updates of email addresses and phone numbers for employees of a single corporation. The comparison is discriminative in that a user's activity features may be compared with corresponding activity features of fraudulent users as well as the activity features of good users. If a user's activity features fit the activity features of fraudulent users more than they fit the activity features of good users, then the new user is likely to be a fraudulent user. Although this example describes individual activity features, such as providing bulk updates for 1,000 contacts, the database system does not calculate an activity trust score based on any single activity feature or use any single activity feature to determine whether or not to restrict a user from interacting with the database. For example, many legitimate users may provide bulk updates for 1,000 contacts, such that the database system would be making an incorrect decision by calculating the activity trust score based only on providing bulk updates for 1,000 contacts or determining whether to restrict a user from interacting with the database based only on providing bulk updates for 1,000 contacts.

Furthermore, the activity features may actually exclude any feature associated with contributing data which is verified as bad data. For example, although the database system may automatically identify some updated record as bad records using an email verifier, such as Brite Verify®., the database system does not use the identification of these bad records to calculate the user activity score. Instead, the database system calculates a user's activity trust score based on a combination of activity features, which when evaluated alone are insufficient to accurately predict whether a user is likely to become a fraudulent user.

Although the following simplified example describes the database system assigning a weight to activity features associated with previous users, the database system may use more advanced machine learning algorithms to leverage dependencies among activity features to yield potentially more accurate predictions. In this example, the database system may assign a weight to each of the activity features based on the corresponding activity features associated with previous users who are restricted from interacting with the database and/or the corresponding activity features associated with previous users who are currently enabled to interact with the database.

The database system may train with the activity features associated with half of the previous users who are locked out from accessing the database to identify correlations between each activity feature and these fraudulent users. Next the database system may assign weights based on the correlations, such as assigning a weight to providing updates for employees of a single corporation that is 1.25 times the weight of the weight assigned to providing bulk updates. Then the database system may calculate activity trust scores for the activity features associated with the remaining half of the previous users who are locked out from accessing the database to verify that the weights are assigned correctly, and may adjust the assigned weights as needed.

Having calculated the user's activity trust score, the database system may optionally determine whether the activity trust score is above an activity threshold, block 118. In embodiments, this can include the database system comparing the user's activity trust score of 95 to an activity threshold of 90. If the database system determines that the activity trust score is above the activity threshold, the method 100 continues to block 120. If the database system determines that the activity trust score is not above the activity threshold, the method 100 proceeds to block 122.

The following example describes how database system may calculate the activity threshold based on a desired precision and recall. The method that the database system uses for selecting the activity threshold may be a more advanced version of the aforementioned method for selecting the registration threshold. The additional sophistication may be needed because activities are temporal in nature. In the data set (rau, c, t), u denotes a user, rau denotes the user's vector of “registration plus activity” features, c denotes whether u is fraudulent (F) or not (N), and t denotes the time when the user registered plus a period of time, such as exactly one month. Although this example specifies that rau denotes the user's vector of “registration plus activity” features, rau may denote the user's vector of activity features. The rau of a user may be snap-shotted at exactly this time t, which may be one month after the user registered. In view of this, no single user appears in this data set more than once.

The database system may hold out some recent data, such as the most recent two months of data in terms of t, for setting the activity threshold, and train the classifier on the rest of the data. In this example, the classifier is trained on the combination of registration and activity features to predict c, such as F or N, but the classifier may be trained only on the activity features to predict c. Once the model has been trained, a database system administrator may choose the activity threshold by evaluating the trained model's accuracy, on different feature sets at varying time scales, on the same held-out set.

To simplify the following example, there are only two time scales of interest: within the first week of registration and within the first month of registration. To score each held-out item for the first time scale, the database system may nullify all activity features in rau whose values cannot be determined from the activity in the first week after registration. To score each held-out item for the second time scale, the database system may use all the features in rau. Thus, for each item in the held-out set, the database system may get two user trust scores from the trained classifier, one for each time scale. For each time scale, the database system may compute the score threshold that yields the highest recall for a given minimum precision, exactly as described in the previous section for computing the registration threshold. The result is a sequence of thresholds, one for each time scale. Then the database system may apply the threshold that corresponds to the time scale of the particular user.

If the activity trust score is above the activity threshold, the database system may optionally restrict the user from interacting with the database, block 120. For example and without limitation, this can include the database system restricting the user from interacting with the database because the user's activity trust score of 95 is above the activity threshold of 90. Then the method 100 terminates.

If the activity trust score is not above the activity threshold, the database system may optionally determine whether the activity trust score is above an auxiliary activity threshold, block 122. By way of example and without limitation, this can include the database system comparing a user's activity trust score of 85 to an auxiliary activity threshold of 80. If the database system determines that the activity trust score is above the auxiliary activity threshold, the method 100 continues to block 124. If the database system determines that the activity trust score is not above the auxiliary activity threshold, the method 100 terminates.

If the activity trust score is above the auxiliary activity threshold, the database system may optionally output a message requesting evaluation whether to restrict user from interacting with database, block 124. In embodiments, this can include the database system notifying system administrators that the user's activity trust score of 85 is above the auxiliary activity threshold of 80, which enables to system administrators to review the user's activity features and determine whether or not to lock out the user from accessing the database.

Although the previous examples describe activity trust scores which are independent of the registration trust scores, the database system may calculate activity trust scores which are dependent upon the registration trust scores. For example, the database system may calculate an activity trust score of 95 for a user, which is based partially on the user providing bulk updates of email addresses and phone numbers for 1,000 employees of Acme corporation, and is based partially on the user's registration trust score of 85, which is based on the user registering with a domain name associated with an area where the headquarters of a competitor of Acme corporation is located and previous fraudulent attempts have been made to update records in the database for Acme corporation. Although this example describes the database system using a separate registration trust score and a separate activity trust score, the database system may use a machine learning algorithm that learns to create a combined registration and activity trust score based the probability that a user is fraudulent, by using a combination of registration and activity features. Using this combined registration and activity trust score may be more accurate than using a separate registration trust score and a separate activity trust score because the combined registration and activity trust score may take potential cross-interactions among the set of registration features and the set of activity features into account.

The method 100 may be repeated as desired. Although this disclosure describes the blocks 102-124 executing in a particular order, the blocks 102-124 may be executed in a different order. In other implementations, each of the blocks 102-124 may also be executed in combination with other blocks and/or some blocks may be divided into a different set of blocks.

FIG. 2 illustrates an example table 200 of registration features for user trust scores based on registration features, under an embodiment. The data structure 200 includes a user registration trust score 202, which the database system calculates based on the user's registration features. If the database system identifies too many of the user's registration features as corresponding to registration features of previous users who are restricted from accessing the database and too few of the user's registration features as corresponding to registration features of previous users who are currently enabled to access the database, the database system may calculate a high user's registration trust score, which may be above a registration threshold, such that the database system may not permit the user to interact with the database.

### System Overview

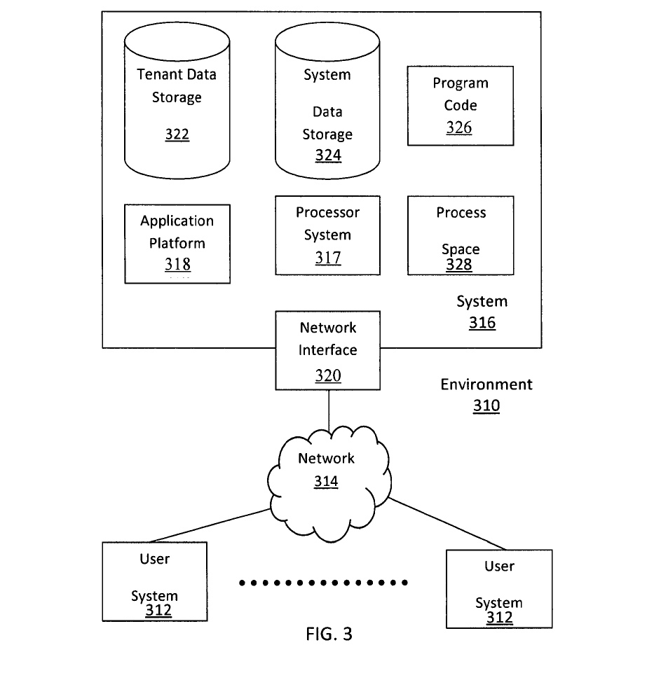

FIG. 3 illustrates a block diagram of an environment 310 wherein an on-demand database service might be used. The environment 310 may include user systems 312, a network 314, a system 316, a processor system 317, an application platform 318, a network interface 320, a tenant data storage 322, a system data storage 324, program code 326, and a process space 328. In other embodiments, the environment 310 may not have all of the components listed and/or may have other elements instead of, or in addition to, those listed above.

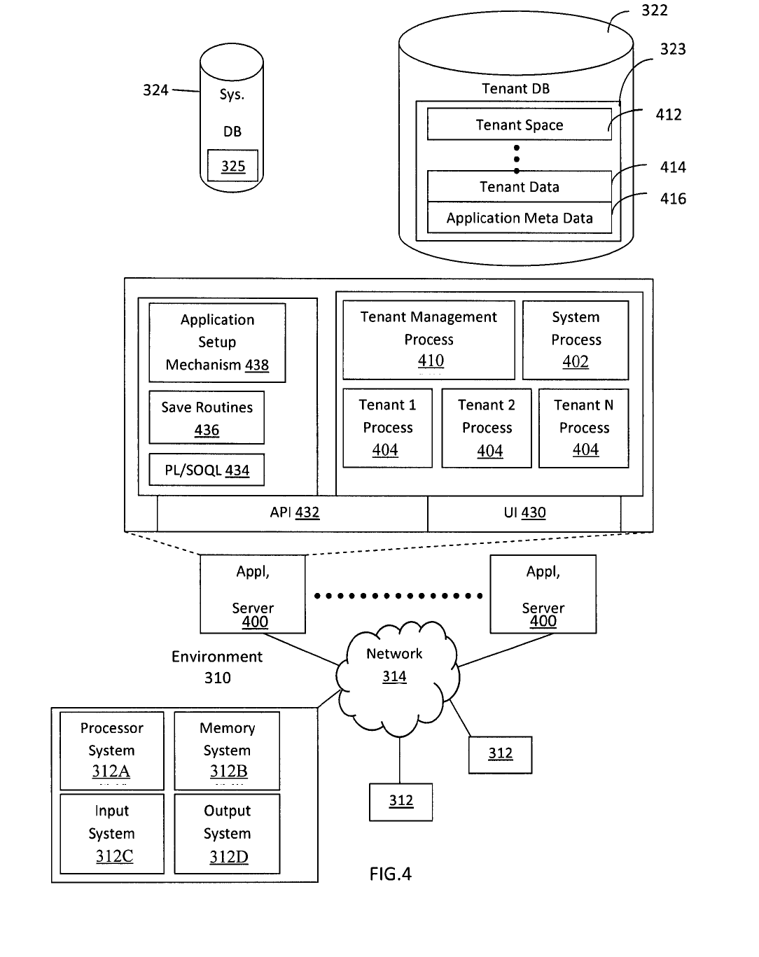

The environment 310 is an environment in which an on-demand database service exists. A user system 312 may be any machine or system that is used by a user to access a database user system. For example, any of the user systems 312 may be a handheld computing device, a mobile phone, a laptop computer, a work station, and/or a network of computing devices. As illustrated in FIG. 3 (and in more detail in FIG. 4) the user systems 312 might interact via the network 314 with an on-demand database service, which is the system 316.

An on-demand database service, such as the system 316, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, the “on-demand database service 316” and the “system 316” will be used interchangeably herein. A database image may include one or more database objects. A relational database management system (RDMS) or the equivalent may execute storage and retrieval of information against the database object(s). The application platform 318 may be a framework that allows the applications of the system 316 to run, such as the hardware and/or software, e.g., the operating system. In an embodiment, the on-demand database service 316 may include the application platform 318 which enables creation, managing and executing one or more applications developed by the provider of the on-demand database service, users accessing the on-demand database service via user systems 312, or third party application developers accessing the on-demand database service via the user systems 312.

The users of the user systems 312 may differ in their respective capacities, and the capacity of a particular user system 312 might be entirely determined by permissions (permission levels) for the current user. For example, where a salesperson is using a particular user system 312 to interact with the system 316, that user system 312 has the capacities allotted to that salesperson. However, while an administrator is using that user system 312 to interact with the system 316, that user system 312 has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

The network 314 is any network or combination of networks of devices that communicate with one another. For example, the network 314 may be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the one or more implementations might use are not so limited, although TCP/IP is a frequently implemented protocol.

The user systems 312 might communicate with the system 316 using TCP/IP and, at a higher network level, use other common Internet protocols to communicate, such as HTTP, FTP, AFS, WAP, etc. In an example where HTTP is used, the user systems 312 might include an HTTP client commonly referred to as a “browser” for sending and receiving HTTP messages to and from an HTTP server at the system 316. Such an HTTP server might be implemented as the sole network interface between the system 316 and the network 314, but other techniques might be used as well or instead. In some implementations, the interface between the system 316 and the network 314 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, the system 316, shown in FIG. 3, implements a web-based customer relationship management (CRM) system. For example, in one embodiment, the system 316 includes application servers configured to implement and execute CRM software applications as well as provide related data, code, forms, webpages and other information to and from the user systems 312 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, the system 316 implements applications other than, or in addition to, a CRM application. For example, the system 316 may provide tenant access to multiple hosted (standard and custom) applications, including a CRM application. User (or third party developer) applications, which may or may not include CRM, may be supported by the application platform 318, which manages creation, storage of the applications into one or more database objects and executing of the applications in a virtual machine in the process space of the system 316.

One arrangement for elements of the system 316 is shown in FIG. 3, including the network interface 320, the application platform 318, the tenant data storage 322 for tenant data 323, the system data storage 324 for system data 325 accessible to the system 316 and possibly multiple tenants, the program code 326 for implementing various functions of the system 316, and the process space 328 for executing MTS system processes and tenant-specific processes, such as running applications as part of an application hosting service. Additional processes that may execute on the system 316 include database indexing processes.

Several elements in the system shown in FIG. 3 include conventional, well-known elements that are explained only briefly here. For example, each of the user systems 312 could include a desktop personal computer, workstation, laptop, PDA, cell phone, or any wireless access protocol (WAP) enabled device or any other computing device capable of interfacing directly or indirectly to the Internet or other network connection. Each of the user systems 312 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of the user systems 312 to access, process and view information, pages and applications available to it from the system 316 over the network 314. Each of the user systems 312 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by the system 316 or other systems or servers. For example, the user interface device may be used to access data and applications hosted by the system 316, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each of the user systems 312 and all of its components are operator configurable using applications, such as a browser, including computer code run using a central processing unit such as an Intel Pentium® processor or the like. Similarly, the system 316 (and additional instances of an MTS, where more than one is present) and all of their components might be operator configurable using application(s) including computer code to run using a central processing unit such as the processor system 317, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein.

Computer code for operating and configuring the system 316 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, the system 316 is configured to provide webpages, forms, applications, data and media content to the user (client) systems 312 to support the access by the user systems 312 as tenants of the system 316. As such, the system 316 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations.

Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 4 also illustrates the environment 310. However, in FIG. 4 elements of the system 316 and various interconnections in an embodiment are further illustrated. FIG. 4 shows that the each of the user systems 312 may include a processor system 312A, a memory system 312B, an input system 312C, and an output system 312D. FIG. 4 shows the network 314 and the system 316. FIG. 4 also shows that the system 316 may include the tenant data storage 322, the tenant data 323, the system data storage 324, the system data 325, a User Interface (UI) 430, an Application Program Interface (API) 432, a PL/SOQL 434, save routines 436, an application setup mechanism 438, applications servers 4001-400N, a system process space 402, tenant process spaces 404, a tenant management process space 410, a tenant storage area 412, a user storage 414, and application metadata 416. In other embodiments, the environment 310 may not have the same elements as those listed above and/or may have other elements instead of, or in addition to, those listed above.

The user systems 312, the network 314, the system 316, the tenant data storage 322, and the system data storage 324 were discussed above in FIG. 3. Regarding the user systems 312, the processor system 312A may be any combination of one or more processors. The memory system 312B may be any combination of one or more memory devices, short term, and/or long term memory. The input system 312C may be any combination of input devices, such as one or more keyboards, mice, trackballs, scanners, cameras, and/or interfaces to networks. The output system 312D may be any combination of output devices, such as one or more monitors, printers, and/or interfaces to networks.

As shown by FIG. 4, the system 316 may include the network interface 320 (of FIG. 3) implemented as a set of HTTP application servers 400, the application platform 318, the tenant data storage 322, and the system data storage 324. Also shown is the system process space 402, including individual tenant process spaces 404 and the tenant management process space 410. Each application server 400 may be configured to access tenant data storage 322 and the tenant data 323 therein, and the system data storage 324 and the system data 325 therein to serve requests of the user systems 312. The tenant data 323 might be divided into individual tenant storage areas 412, which can be either a physical arrangement and/or a logical arrangement of data. Within each tenant storage area 412, the user storage 414 and the application metadata 416 might be similarly allocated for each user. For example, a copy of a user's most recently used (MRU) items might be stored to the user storage 414. Similarly, a copy of MRU items for an entire organization that is a tenant might be stored to the tenant storage area 412. The UI 430 provides a user interface and the API 432 provides an application programmer interface to the system 316 resident processes to users and/or developers at the user systems 312. The tenant data and the system data may be stored in various databases, such as one or more Oracle™ databases.

The application platform 318 includes the application setup mechanism 438 that supports application developers' creation and management of applications, which may be saved as metadata into the tenant data storage 322 by the save routines 436 for execution by subscribers as one or more tenant process spaces 404 managed by the tenant management process 410 for example. Invocations to such applications may be coded using the PL/SOQL 434 that provides a programming language style interface extension to the API 432. A detailed description of some PL/SOQL language embodiments is discussed in commonly owned U.S. Pat. No. 7,730,478 entitled, METHOD AND SYSTEM FOR ALLOWING ACCESS TO DEVELOPED APPLICATIONS VIA A MULTI-TENANT ON-DEMAND DATABASE SERVICE, by Craig Weissman, filed Sep. 21, 2007, which is incorporated in its entirety herein for all purposes. Invocations to applications may be detected by one or more system processes, which manages retrieving the application metadata 416 for the subscriber making the invocation and executing the metadata as an application in a virtual machine.

Each application server 400 may be communicably coupled to database systems, e.g., having access to the system data 325 and the tenant data 323, via a different network connection. For example, one application server 4001 might be coupled via the network 314 (e.g., the Internet), another application server 400N-1 might be coupled via a direct network link, and another application server 400N might be coupled by yet a different network connection. Transfer Control Protocol and Internet Protocol (TCP/IP) are typical protocols for communicating between application servers 400 and the database system. However, it will be apparent to one skilled in the art that other transport protocols may be used to optimize the system depending on the network interconnect used.

In certain embodiments, each application server 400 is configured to handle requests for any user associated with any organization that is a tenant. Because it is desirable to be able to add and remove application servers from the server pool at any time for any reason, there is preferably no server affinity for a user and/or organization to a specific application server 400. In one embodiment, therefore, an interface system implementing a load balancing function (e.g., an F5 Big-IP load balancer) is communicably coupled between the application servers 400 and the user systems 312 to distribute requests to the application servers 400. In one embodiment, the load balancer uses a least connections algorithm to route user requests to the application servers 400. Other examples of load balancing algorithms, such as round robin and observed response time, also can be used. For example, in certain embodiments, three consecutive requests from the same user could hit three different application servers 400, and three requests from different users could hit the same application server 400. In this manner, the system 316 is multi-tenant, wherein the system 316 handles storage of, and access to, different objects, data and applications across disparate users and organizations.

As an example of storage, one tenant might be a company that employs a sales force where each salesperson uses the system 316 to manage their sales process. Thus, a user might maintain contact data, leads data, customer follow-up data, performance data, goals and progress data, etc., all applicable to that user's personal sales process (e.g., in the tenant data storage 322). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by the system 316 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, the system 316 might also maintain system level data usable by multiple tenants or other data. Such system level data might include industry reports, news, postings, and the like that are sharable among tenants.

In certain embodiments, the user systems 312 (which may be client systems) communicate with the application servers 400 to request and update system-level and tenant-level data from the system 316 that may require sending one or more queries to the tenant data storage 322 and/or the system data storage 324. The system 316 (e.g., an application server 400 in the system 316) automatically generates one or more SQL statements (e.g., one or more SQL queries) that are designed to access the desired information. The system data storage 324 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. Pat. No. 7,779,039, filed Apr. 2, 2004, entitled “Custom Entities and Fields in a Multi-Tenant Database System”, which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. A system for user trust scores based on registration features, the apparatus comprising:
one or more processors; and
a non-transitory computer readable medium storing a plurality of instructions, which when executed, cause the one or more processors to:
identify a plurality of registration features associated with a user registered to interact with a database;
calculate a registration trust score for the user based on a comparison of a plurality of the plurality of registration features associated with the user to at least one of a corresponding plurality of registration features associated with previous users who are restricted from interacting with the database and a corresponding plurality of registration features associated with previous users who are enabled to interact with the database;
determine if the registration trust score is above a registration threshold; and
restrict the user from interacting with the database in response to a determination that the registration trust score is above the registration threshold.

2. The system of claim 1, comprising further instructions, which when executed, cause the one or more processors to:
determine if the registration trust score is above a second registration threshold; and
output a message requesting an evaluation whether to restrict the user from interacting with the database in response to a determination that the registration trust score is above the second registration threshold.

3. The system of claim 1, wherein the plurality of registration features comprise at least one of a name of the user, an internet protocol address of the user, an email address of the user, and when the user registered, and wherein each of the plurality of registration features is assigned a weight based on at least one of the corresponding plurality of registration features associated with previous users who are restricted from interacting with the database and the corresponding plurality of registration features associated with previous users who are enabled to interact with the database.

4. The system of claim 1, comprising further instructions, which when executed, cause the one or more processors to:
identify a plurality of activity features associated with the user;
calculate an activity trust score for the user based on a comparison of a plurality of the plurality of activity features associated with the user to at least one of a corresponding plurality of activity features associated with previous users who are restricted from interacting with the database and a corresponding plurality of activity features associated with previous users who are enabled to interact with the database;
determine if the activity trust score is above an activity threshold; and
restrict the user from interacting with the database in response to a determination that the activity trust score is above the activity threshold.

5. The system of claim 4, comprising further instructions, which when executed, cause the one or more processors to:
determine if the activity trust score is above a second activity threshold; and
output a message requesting an evaluation whether to restrict the user from interacting with the database in response to a determination that the activity trust score is above the second activity threshold.

6. The system of claim 4, wherein the plurality of activity features comprise at least one of a frequency of providing updates, a type of updates provided, a percentage of data for an entity which is provided by updates from the user, and wherein each of the plurality of activity features is assigned a weight based on at least one of the corresponding plurality of activity features associated with previous users who are restricted from interacting with the database and the corresponding plurality of activity features associated with previous users who are enabled to interact with the database.

7. The system of claim 4, wherein the plurality of activity features excludes any feature associated with contributing data which is verified as bad data.

8. A computer program product comprising computer-readable program code to be executed by one or more processors when retrieved from a non-transitory computer-readable medium, the program code including instructions to:
identify a plurality of registration features associated with a user registered to interact with a database;
calculate a registration trust score for the user based on a comparison of a plurality of the plurality of registration features associated with the user to at least one of a corresponding plurality of registration features associated with previous users who are restricted from interacting with the database and a corresponding plurality of registration features associated with previous users who are enabled to interact with the database;
determine if the registration trust score is above a registration threshold; and
restrict the user from interacting with the database in response to a determination that the registration trust score is above the registration threshold.

9. The computer program product of claim 8, wherein the program code comprises further instructions to:
determine if the registration trust score is above a second registration threshold; and
output a message requesting an evaluation whether to restrict the user from interacting with the database in response to a determination that the registration trust score is above the second registration threshold.

10. The computer program product of claim 8, wherein the plurality of registration features comprise at least one of a name of the user, an interne protocol address of the user, an email address of the user, and when the user registered, and wherein each of the plurality of registration features is assigned a weight based on at least one of the corresponding plurality of registration features associated with previous users who are restricted from interacting with the database and the corresponding plurality of registration features associated with previous users who are enabled to interact with the database.

11. The computer program product of claim 8, wherein the program code comprises further instructions to:
identify a plurality of activity features associated with the user;
calculate an activity trust score for the user based on a comparison of a plurality of the plurality of activity features associated with the user to at least one of a corresponding plurality of activity features associated with previous users who are restricted from interacting with the database and a corresponding plurality of activity features associated with previous users who are enabled to interact with the database;
determine if the activity trust score is above an activity threshold; and
restrict the user from interacting with the database in response to a determination that the activity trust score is above the activity threshold.

12. The computer program product of claim 11, wherein the program code comprises further instructions to:
determine if the activity trust score is above a second activity threshold; and
output a message requesting an evaluation whether to restrict the user from interacting with the database in response to a determination that the activity trust score is above the second activity threshold.

13. The computer program product of claim 11, wherein the plurality of activity features comprise at least one of a frequency of providing updates, a type of updates provided, a percentage of data for an entity which is provided by updates from the user, and wherein each of the plurality of activity features is assigned a weight based on at least one of the corresponding plurality of activity features associated with previous users who are restricted from interacting with the database and the corresponding plurality of activity features associated with previous users who are enabled to interact with the database.

14. The computer program product of claim 11, wherein the plurality of activity features excludes any feature associated with contributing data which is verified as bad data.

15. A method for user trust scores based on registration features, the method comprising:
identifying a plurality of registration features associated with a user registered to interact with a database;
calculating a registration trust score for the user based on a comparison of a plurality of the plurality of registration features associated with the user to at least one of a corresponding plurality of registration features associated with previous users who are restricted from interacting with the database and a corresponding plurality of registration features associated with previous users who are enabled to interact with the database;
determining if the registration trust score is above a registration threshold; and
restricting the user from interacting with the database in response to a determination that the registration trust score is above the registration threshold.

16. The method of claim 15, the method further comprising:
determining if the registration trust score is above a second registration threshold; and
outputting a message requesting an evaluation whether to restrict the user from interacting with the database in response to a determination that the registration trust score is above the second registration threshold.

17. The method of claim 15, wherein the plurality of registration features comprise at least one of a name of the user, an internet protocol address of the user, an email address of the user, and when the user registered, and wherein each of the plurality of registration features is assigned a weight based on at least one of the corresponding plurality of registration features associated with previous users who are restricted from interacting with the database and the corresponding plurality of registration features associated with previous users who are enabled to interact with the database.

18. The method of claim 15, the method further comprising:
identifying a plurality of activity features associated with the user;
calculating an activity trust score for the user based on a comparison of a plurality of the plurality of activity features associated with the user to at least one of a corresponding plurality of activity features associated with previous users who are restricted from interacting with the database and a corresponding plurality of activity features associated with previous users who are enabled to interact with the database;
determining if the activity trust score is above an activity threshold; and
restricting the user from interacting with the database in response to a determination that the activity trust score is above the activity threshold.

19. The method of claim 18, the method further comprising:
determining if the activity trust score is above a second activity threshold; and
outputting a message requesting an evaluation whether to restrict the user from interacting with the database in response to a determination that the activity trust score is above the second activity threshold.

20. The method of claim 18, wherein the plurality of activity features comprise at least one of a frequency of providing updates, a type of updates provided, a percentage of data for an entity which is provided by updates from the user, and wherein each of the plurality of activity features is assigned a weight based on at least one of the corresponding plurality of activity features associated with previous users who are restricted from interacting with the database and the corresponding plurality of activity features associated with previous users who are enabled to interact with the database.
